(19) United States
(12) Patent Application Publication
(10) Pub. No.: US 2026/0119375 A1
(43) Pub. Date: Apr. 30, 2026

(54) TESTING AND VALIDATION OF TOOLS FOR ARTIFICIAL INTELLIGENCE AGENTS USING ARTIFICIAL INTELLIGENCE

(71) Applicant: BOOMI, LP, Conshohocken, PA (US)

(72) Inventors: Thomas BENJAMIN, Foster City, CA (US); Ayush PARASHAR, Foster City, CA (US); Christopher PEDROTTI, San Jose, CA (US); Lomesh AGRAWAL, Toronto (CA); Kashif MOHAMMAD, Nagpur (IN)

(73) Assignee: BOOMI, LP, Conshohocken, PA (US)

(21) Appl. No.: 19/249,646

(22) Filed: Jun. 25, 2025

(30) Foreign Application Priority Data
Oct. 25, 2024 (IN) 202411081538

(51) Int. Cl. G06F 11/3668; G06F 40/295

(52) U.S. Cl. CPC G06F 11/3684; G06F 11/3688; G06F 40/295

(57) ABSTRACT

Conventional testing of artificial intelligence (AI) agents is time-consuming and insufficient. Accordingly, embodiments provide an automated testing and validation framework for the tools utilized by AI agents. The framework may leverage artificial intelligence, including a classifier for classifying tools, a generative model that creates test cases based on the tool classification, an optimization model that maximizes test coverage while minimizing computation cost, an edge-detection model that identifies edge test cases, and/or an execution engine that manages execution of the test suite. The framework may be integrated into a continuous integration and continuous deployment (CI/CI) pipeline.

### CROSS-REFERENCE TO RELATED APPLICATIONS

The present application claims priority to Indian Patent Application number 202411081538, filed on Oct. 25, 2024, which is hereby incorporated herein by reference as if set forth in full.

### BACKGROUND

### Field of the Invention

The embodiments described herein are generally directed to artificial intelligence (AI), and, more particularly, to the testing and validation of tools for AI agents using artificial intelligence.

### Description of the Related Art

A number of platforms exist that enable users to construct artificial intelligence (AI) agents. An AI agent is a software entity that utilizes artificial intelligence to autonomously perform one or more tasks, in order to achieve an objective set by a human, another software entity (e.g., another AI agent), or other system. An AI agent may comprise or communicate with one or more integrated, local, or remote AI models, such as generative AI models (e.g., generative language models, generative image models, generative coding models, etc.). An AI agent may also communicate with one or more tools that are external to the AI agent, to complete tasks in furtherance of its objective. The AI agent may communicate with an AI model and/or tool using an application programming interface (API).

Existing platforms typically require users to manually define, configure, test, and validate each component of the AI agent, including the tools and application programming interfaces. Of particular relevance to the present disclosure, the testing and validation of tools and application programming interfaces is particularly challenging. These challenges include time-consuming testing processes, difficulty in ensuring compatibility between tools, application programming interfaces, and the AI agent's objectives, limited ability to detect and handle tool-specific errors and API exceptions, and potential security and compliance risks due to inadequate validation.

Naturally, such challenges result in increased development time, reduced reliability and performance, and difficult in maintaining and updating the tools, including their respective application programming interfaces. In addition, users must possess significant technical knowledge and spend considerable time and effort to test a new AI agent, including the interactions between the AI agent and its respective tool(s). As a result, there is a high barrier to entry, as well as a high likelihood of coverage gaps and inefficiencies, especially for non-technical users.

### SUMMARY

Accordingly, systems, methods, and non-transitory computer-readable media are disclosed for the testing and validation of tools for artificial intelligence (AI) agents using artificial intelligence.

In an embodiment, a method comprises using at least one hardware processor to, by a testing engine: receive a tool specification that defines a tool for an artificial intelligence (AI) agent; classify the tool into one of a plurality of classifications based on the tool specification; generate a test suite, comprising a plurality of test cases, based on the one classification, using a generative model; apply an optimization model to the test suite to optimize the test suite; detect one or more edge cases based on the tool specification; add the detected one or more edge cases, as test cases, to the test suite; execute the test suite on the tool to produce a test result; and output the test result.

The tool specification may comprise an application programming interface (API) specification that defines an application programming interface of the tool.

Classifying the tool may comprise: extracting one or more features from the tool specification; and applying a machine-learning classifier to the one or more features to output the one classification. Applying the machine-learning classifier may comprise: applying a language model to the one or more features to determine the one classification; applying a named entity recognition (NER) model to the one or more features to recognize one or more named entities within the one or more features; and verify the one classification based on the one or more named entities.

Each of the plurality of classifications may represent a different one of a plurality of types of tool than any other of the plurality of classifications.

The plurality of types of tool may comprise a Representational State Transfer (REST) application programming interface, an integration process, and a data hub.

The generative model may comprise a large language model. Executing the generative model to generate the test suite may comprise: generating a prompt that incorporates the one classification and one or more elements derived from the tool specification, and instructs the large language model to generate the test suite; and inputting the prompt to the large language model to generate the test suite as output.

Generating the test suite may comprise: generating a first set of test cases based on one or more rules, applied to the one classification and one or more first elements derived from the tool specification; and generating a second set of test cases by applying the generative model to the one classification and one or more second elements derived from the tool specification; wherein the test suite comprises the first set of test cases and the second set of test cases.

Optimizing the test suite may comprise reducing a number of the plurality of test cases within the test suite, while maintaining a similar coverage as the test suite prior to optimization.

The optimization model may comprise an extreme Gradient Boosting (XGBoost) ranking model.

Detecting the one or more edge cases may comprise executing one or more edge-detection models. The one or more edge-detection models may comprise a transformer-based fuzzy model. The one or more edge-detection models may comprise an anomaly detection ensemble that includes two or more of an isolation forest, an autoencoder, or a support vector machine.

The generation engine may be an AI agent.

The method may further comprise using the at least one hardware processor to: receive feedback for the test suite; and update one or more models of the testing engine based on the feedback.

The method may further comprise using the at least one hardware processor to deploy the AI agent to a computing environment.

The method may be automatically executed within a continuous integration and continuous deployment (CI/CD) pipeline.

It should be understood that any of the features in the methods above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein may be implemented, according to an embodiment;

FIG. 2 illustrates an example processing system, by which one or more of the processes described herein may be executed, according to an embodiment;

FIG. 3 illustrates an example process for the testing and validation of tools for artificial intelligence (AI) agents using artificial intelligence, according to an embodiment;

FIG. 4 illustrates an example of a subprocess for classifying a tool, according to an embodiment;

FIG. 5 illustrates an example of a subprocess for generating a test suite, according to an embodiment; and

FIG. 6 illustrates an example of a subprocess for executing a test suite, according to an embodiment.

### DETAILED DESCRIPTION

After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

In an embodiment, systems, methods, and non-transitory computer-readable media are disclosed for the testing and validation of tools for artificial intelligence (AI) agents using artificial intelligence. Embodiments provide a framework that leverages artificial intelligence, such as machine learning, to test and validate tools, including application programming interfaces, designed for AI agents. This framework may include a classifier that classifies tools, a generative model that creates test cases across normal, boundary, and negative conditions using domain-specific knowledge for the tool classification, an optimization model that maximizes test coverage and minimizes computational cost (e.g., redundancy), an edge-detection model that identifies edge cases and unusual inputs that might cause hidden failures, and/or an execution engine that manages execution of a test suite, comprising the test cases, reporting, integration of test activities within development workflows, and/or the like. Collectively, these components form a framework that ensures the quality and reliability of AI-agent interfaces. The framework streamlines the testing process, ensures compatibility between tools, application programming interfaces, and agentic objectives, enhances the overall reliability and performance of AI agents in enterprise environments, and/or the like. By leveraging, artificial intelligence, such as machine learning, and advanced testing methodologies, the framework enables efficient validation of tools, including application programming interfaces, data integrations, queries of knowledge bases, and/or the like.

### 1. Infrastructure

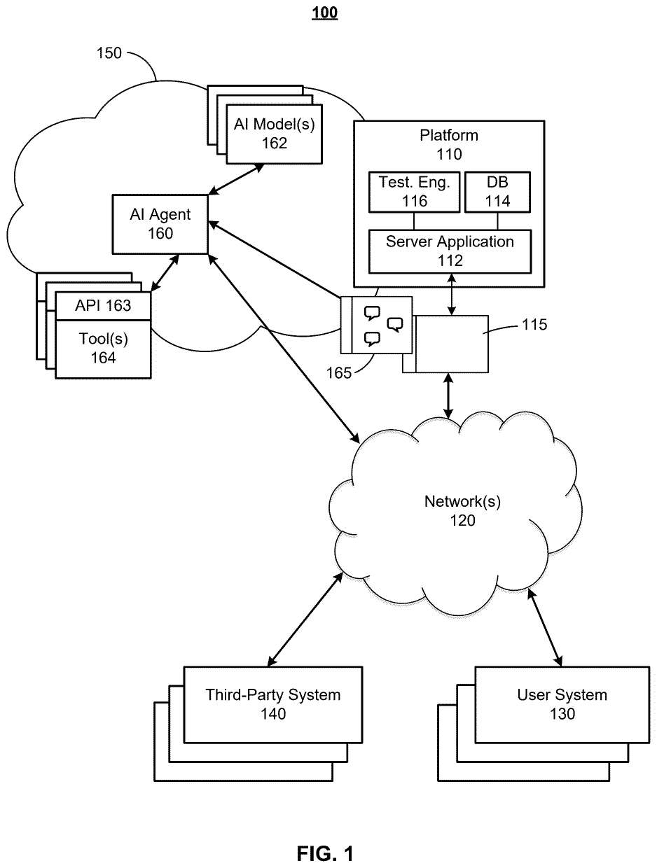

FIG. 1 illustrates an example infrastructure 100, in which one or more of the processes described herein may be implemented, according to an embodiment. Infrastructure 100 may comprise a platform 110 which hosts, supports, and/or executes one or more of the disclosed processes, which may be implemented in software and/or hardware. In particular, platform 110 may execute a server application 112, and/or host a database 114 that may store data used by server application 112. Platform 110 may also execute a testing engine 116 (e.g., as part of or in collaboration with server application 112), which utilizes artificial intelligence to test and validate a new AI agent 160, as described in greater detail elsewhere herein. In an embodiment, testing engine 116 is itself an AI agent 160. Platform 110 may comprise dedicated servers, or may instead be implemented in a computing cloud, in which the resources of one or more servers are dynamically and elastically allocated to multiple tenants based on demand. In either case, the servers may be collocated and/or geographically distributed.

Platform 110 may be communicatively connected to one or more networks 120. Network(s) 120 enable communication between platform 110 and one or more user systems 130 and/or third-party systems 140. Network(s) 120 may comprise the Internet, and communication through network(s) 120 may utilize standard transmission protocols, such as HTTP, HTTP Secure (HTTPS), File Transfer Protocol (FTP), FTP Secure (FTPS), Secure Shell FTP (SFTP), and the like, as well as proprietary protocols. While platform 110 is illustrated as being connected to a plurality of user systems 130 and/or third-party system(s) 140 through a single set of network(s) 120, it should be understood that platform 110 may be connected to different user systems 130 and/or third-party systems 140 via different sets of one or more networks. For example, platform 110 may be connected to a subset of user systems 130 and/or third-party systems 140 via the Internet, but may be connected to another subset of user systems 130 and/or third-party systems 140 via an intranet.

While only a few user systems 130 are illustrated, it should be understood that platform 110 may be communicatively connected to any number of user system(s) 130 via network(s) 120. User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. However, it is generally contemplated that a user system 130 would be the personal computer or professional workstation of a developer or other stakeholder in AI agents 160, who has a user account for accessing server application 112 on platform 110. It should be understood that the user may be anywhere from an expert software engineer, with extensive knowledge of how to construct an AI agent 160, to a business decision-maker, lay person, or other non-technical person, with little to no knowledge of how to construct an AI agent 160. Each user account may be associated with an overarching organizational account for managing software entities, including AI agents 160, being developed by an organization using platform 110.

Server application 112 may manage a computing environment 150. In particular, server application 112 may provide a user interface 115 and backend functionality, including one or more of the processes disclosed herein, to enable or otherwise support users, via user systems 130, to construct, develop, modify, save, delete, test, deploy, un-deploy, and/or otherwise manage software entities within computing environment 150. User interface 115 may comprise a graphical user interface that implements a low-code environment, including potentially a no-code environment, in which users may construct software entities. These software entities may comprise AI agents 160, and potentially other software entities, such as integration processes.

The user of a user system 130 may authenticate with platform 110 using standard authentication means, to access server application 112 in accordance with permissions or roles of the associated user account. The user may then interact with server application 112 to manage one or more software entities, for example, within a larger software platform within computing environment 150. It should be understood that multiple users, on multiple user systems 130, may manage the same software entities and/or different software entities in this manner, according to the permissions or roles of their associated user accounts.

In an embodiment, platform 110 may be an integration platform as a service (iPaaS) platform. In this case, the software entities(s) being developed may include integration process(es). Computing environment 150 may comprise one or a plurality of integration platforms that each comprises one or a plurality of integration processes. Each integration platform may be associated with an organization, which may be associated with one or more user accounts by which respective user(s) manage the organization's integration platform, including the various integration process(es). An integration process may represent a transaction involving the integration of data between two or more systems, and may comprise a series of elements that specify logic and transformation requirements for the data to be integrated. Each element, which may also be referred to as a “step,” may transform, route, and/or otherwise manipulate data to attain an end result from input data. For example, a basic integration process may receive data from one or more data sources (e.g., via an application programming interface of the integration process), manipulate the received data in a specified manner (e.g., including mapping, analyzing, normalizing, altering, updating, enhancing, and/or augmenting the received data), and send the manipulated data to one or more specified destinations (e.g., via an application programming interface of each destination). An integration process may represent a business workflow or a portion of a business workflow or a transaction-level interface between two systems, and comprise, as one or more elements, software modules that process data to implement the business workflow or interface. A business workflow may comprise any myriad of workflows of which an organization may repetitively have need. For example, a business workflow may comprise, without limitation, procurement of parts or materials, manufacturing a product, selling a product, shipping a product, ordering a product, billing, managing inventory or assets, providing customer service, ensuring information security, marketing, onboarding or offboarding an employee, assessing risk, obtaining regulatory approval, reconciling data, auditing data, providing information technology services, and/or any other workflow that an organization may implement in software. These integration processes, and/or the development and/or management of these integration processes, may be supported by one or more AI agents 160, and/or the integration processes may support AI agents 160, for example, as tools 164 that are utilized by AI agents 160.

Each integration process, when deployed, may be communicatively coupled to network(s) 120. For example, each integration process may comprise an application programming interface that enables clients to access an integration process via network(s) 120. A client may push data to an integration process through application programming interface, and/or pull data from an integration process through the application programming interface.

One or more third-party systems 140 may be communicatively connected to network(s) 120, such that each third-party system 140 may communicate with an AI agent 160 and/or integration process in computing environment 150 via an application programming interface. Third-party system 140 may host and/or execute a software application that pushes data to an AI agent 160 and/or integration process and/or pulls data from an AI agent 160 and/or integration process, via the application programming interface of the AI agent 160 or integration process. Additionally or alternatively, an AI agent 160 and/or integration process may push data to a software application on third-party system 140 and/or pull data from a software application on third-party system 140, via an application programming interface of the third-party system 140. Thus, third-party system 140 may be a client or consumer of one or more AI agents 160 and/or integration processes, a data source for one or more AI agents 160 and/or integration processes, and/or the like. As examples, the software application on third-party system 140 may comprise, without limitation, enterprise resource planning (ERP) software, customer relationship management (CRM) software, accounting software, and/or the like.

In an embodiment, the software entities(s) being developed on platform 110 include AI agents 160. An AI agent 160 is any software entity that utilizes artificial intelligence (e.g., machine learning, natural-language processing, data analytics, etc.), embodied in one or more AI models 162, to autonomously perform a task, in order to achieve an objective set by a human, other software entity, or other system. AI agent 160 may collect data, analyze data, communicate with human users and/or other software entities, collaborate with other AI agents 160 to complete a complex task, execute actions, learn and improve over time, and/or the like.

Each AI agent 160 comprises or is communicatively coupled to at least one AI model 162. AI model 162 may be internal to AI agent 160, external but local (i.e., within computing environment 150) to AI agent 160, or external and remote (i.e., outside computing environment 150, e.g., hosted on third-party system 140, etc.) from AI agent 160. An AI model 162 may be a generative AI model, such as a generative language model (e.g., small language model, large language model, etc., that responds to natural-language prompts in natural language), generative image model (e.g., that responds to natural-language prompts with an image), generative video model (e.g., that responds to natural-language prompts with a video), generative coding model (e.g., that responds to natural-language prompts with software code), or the like. As used herein, the term “natural language” or “natural-language” refers to language, including grammar, that would be expected in a normal conversation between two humans. A pre-trained generative AI model may be used as a base model that is fine-tuned for the specific task of AI agent 160, to produce AI model 162.

One well-known example of a large language model is the Generative Pre-trained Transformer (GPT). GPT-4 is the fourth-generation language prediction model in the GPT-n series, created by OpenAI of San Francisco, California. GPT-4 is an autoregressive language model that uses deep learning to produce human-like text. GPT-4 has been pre-trained on a vast amount of text from the open Internet. While GPT-4 is provided as an example, it should be understood that the generative language model may be any generative language model, including past and future generations of GPT, as well as other large language models, such as any of the DeepSeck family of large language models from DeepSeck AI of Hangzhou, Zhejiang, China, any of the Claude family of large language models (e.g., Claude 3 Opus) developed by Anthropic PBC of San Francisco, California, the Falcon large language model (e.g., Falcon 160B) released by the United Arab Emirates' Technology Innovation Institute (TII), the Large Language Model Meta AI (LLaMA) model (e.g., LLAMA 2) released by Meta AI of New York, New York, any of the Gemini family of large language models from Google LLC of Mountain View, California, any of the Mistral family of models released by Mistral AI of Paris, France, and the like.

Examples of generative image models include, without limitation, the DALL-E family of models (e.g., DALL-E, DALL-E 2, or DALL-E 3) from OpenAI, Stable Diffusion (e.g., SD 3.5) from Stability AI Ltd of London, England, United Kingdom, Imagen (e.g., Imagen 3) from Google LLC of Mountain View, California, Midjourney form Midjourney, Inc. of San Francisco, California, Adobe Firefly from Adobe Inc. of San Jose, California, Picasso from Nvidia Corp. of Santa Clara, California, Runway Gen-2 from Runway AI, Inc. of New York City, New York, and the like. Examples of generative video models include, without limitation, Runway Gen-2, the Pika family of models from Pika Labs AI of San Francisco, California, Lumiere from Google LLC, VideoLDM from Nvidia, Make-A-Video from Meta Platforms, Inc. of Menlo Park, California, Synthesia from Synthesia of London, England, United Kingdom, DeepBrain AI from AI Studios of Palo Alto, California, Stable Video Diffusion from Stability AI Ltd, and the like.

Examples of generative coding models include, without limitation, Codex from OpenAI, AlphaCode from Google LLC, Code LLAMA from Meta AI, AlphaFold Code from DeepMind Technologies Limited of London, England, United Kingdom, CodeWhisperer from Amazon Web Services of Seattle, Washington, CodeGen from Salesforce, Inc. of San Francisco, California, StarCoder developed by Hugging Face and ServiceNow Research, Tabnine from Tabnine of Tel Aviv, Israel, and the like.

Each AI agent 160 may comprise or be communicatively coupled to zero, one, or a plurality of tools 164. Tool(s) 164 may be hosted within computing environment 150 (e.g., a cloud-computing environment) and/or externally to computing environment 150 (e.g., on a third-party system 140). AI agent 160 may communicate with a tool 164 via an application programming interface 163 of that tool 164. Application programming interface 163 may provide one or more operations that can be performed by AI agent 160 using the respective tool 164. Each operation may accept zero, one, or a plurality of parameters as input and/or provide an output that comprises data representing a response, an acknowledgement, and/or the like. An operation, which may also be referred to herein as an “endpoint,” may be defined by a base Uniform Resource Locator (URL), a path that indicates the resource or action being requested, an HTTP method defining the action to be performed (e.g., GET, POST, PUT, DELETE, etc.), zero, one, or more request parameters, a response format, an authentication or security protocol, a version number, rate limits, error handling, and/or the like.

Tools 164 enable an AI agent 160 to interact with external systems, and even potentially, the physical world. Each tool 164 may perform a task for the overall objective of AI application 160. A task may comprise retrieving data from a source (e.g., another software entity, a local database hosted within computing environment 150, a remote database hosted externally to computing environment 150, a third-party system, application, or database, an integration process, a knowledge base, etc.), transforming, formatting, mapping, cleaning, or otherwise manipulating data, analyzing data, storing data, sending data (e.g., tabular or other structured data, unstructured data, commands, requests, queries, etc.) to a destination (e.g., another software entity, a local database, a remote database, a third-party system, application, or database, an integration process, knowledge base, etc.), initiating a transaction (e.g., purchase, sale, exchange, trade, etc.), completing a transaction, actuating a physical device (e.g., activate a motor, switch, or other machine component, set or adjust a setpoint for a control parameter, etc.), and/or the like.

In some cases, an AI agent 160 may be an AI chat agent. In this case, AI agent 160 may implement a chat interface 165. Chat interface 165 may be comprised or embedded (e.g., as an overlaid chat frame) within user interface 115. Alternatively, chat interface 165 may be separate and distinct from user interface 115. Chat interface 165 may be a graphical user interface, an audio interface, or a combination of graphical and audio user interface (i.e., an audiovisual interface).

### 2. Example Processing System

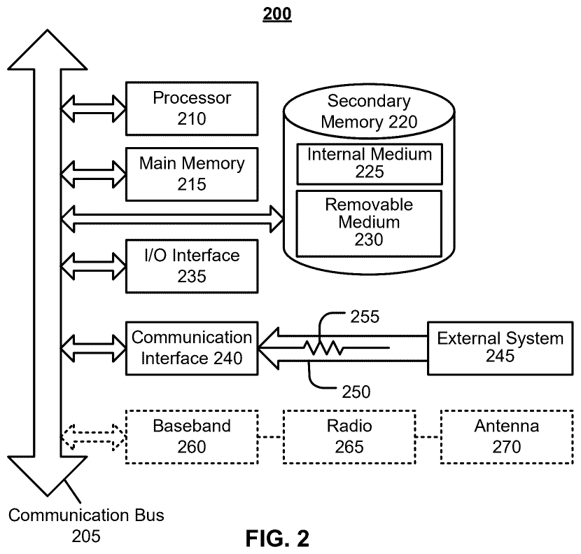

FIG. 2 illustrates an example processing system 200, by which one or more of the processes described herein may be executed, according to an embodiment. For example, system 200 may be used to store and/or execute server application 112, testing engine 116, AI agent 160, AI model(s) 162, tool(s) 164, and/or may represent components of platform 110, user system(s) 130, third-party system(s) 140, and/or other processing devices described herein. System 200 can be any processor-enabled device (e.g., server, personal computer, etc.) that is capable of wired or wireless data communication. Other processing systems and/or architectures may also be used, as will be clear to those skilled in the art.

System 200 may comprise one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 210. Examples of processors which may be used with system 200 include, without limitation, any of the processors (e.g., Pentium™, Core i7™, Core i9™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, any of the processors available from Nvidia Corporation of Santa Clara, California, and/or the like.

Processor(s) 210 may be connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 may comprise main memory 215. Main memory 215 provides storage of instructions and data for programs executing on processor 210, such as any of the software discussed herein. It should be understood that programs stored in the memory and executed by processor 210 may be written and/or compiled according to any suitable language, including without limitation C/C++, Java, JavaScript, Perl, Python, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

System 200 may comprise secondary memory 220. Secondary memory 220 is a non-transitory computer-readable medium having computer-executable code and/or other data (e.g., any of the software disclosed herein) stored thereon. In this description, the term “computer-readable medium” is used to refer to any non-transitory computer-readable storage media used to provide computer-executable code and/or other data to or within system 200. The computer software stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 220 may include an internal medium 225 and/or a removable medium 230. Internal medium 225 and removable medium 230 are read from and/or written to in any well-known manner. Internal medium 225 may comprise one or more hard disk drives, solid state drives, and/or the like. Removable storage medium 230 may be, for example, a magnetic tape drive, a compact disc (CD) drive, a digital versatile disc (DVD) drive, other optical drive, a flash memory drive, and/or the like.

System 200 may comprise an input/output (I/O) interface 235. I/O interface 235 provides an interface between one or more components of system 200 and one or more input and/or output devices. Examples of input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing systems, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch-panel display (e.g., in a smartphone, tablet computer, or other mobile device).

System 200 may comprise a communication interface 240. Communication interface 240 allows software to be transferred between system 200 and external devices, networks, or other information sources. For example, computer-executable code and/or data may be transferred to system 200 from a network server via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 240 is generally in the form of electrical communication signals 255. These signals 255 may be provided to communication interface 240 via a communication channel 250 between communication interface 240 and an external system 245. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code is stored in main memory 215 and/or secondary memory 220. Computer-executable code can also be received from an external system 245 via communication interface 240 and stored in main memory 215 and/or secondary memory 220. Such computer-executable code, when executed, enables system 200 to perform one or more of the various processes disclosed herein.

In an embodiment that is implemented using software, the software may be stored on a computer-readable medium and initially loaded into system 200 by way of removable medium 230, I/O interface 235, or communication interface 240. In such an embodiment, the software is loaded into system 200 in the form of electrical communication signals 255. The software, when executed by processor 210, may cause processor 210 to perform one or more of the various processes disclosed herein.

System 200 may optionally comprise wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, baseband system 260 decodes the signal and converts it to an analog signal. Then, the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 may be communicatively coupled with processor(s) 210, which have access to memory 215 and 220. Thus, software can be received from baseband processor 260 and stored in main memory 210 or in secondary memory 220, or executed upon receipt. Such software, when executed, can enable system 200 to perform one or more of the various processes disclosed herein.

### 3. Overall Process

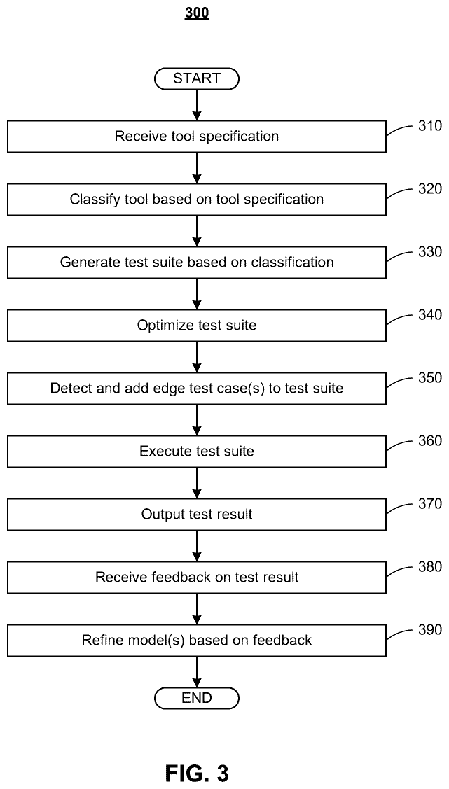

FIG. 3 illustrates an example process 300 for the testing and validation of tools 164 for artificial intelligence (AI) agents 160 using artificial intelligence, according to an embodiment. Process 300 may be implemented in testing engine 116, which may be a software module of server application 112 or a separate software entity, including potentially, an AI agent 160 that utilizes one or more models 162 and zero, one, or more tools 164. Process 300 may be executed whenever a new tool 164 needs to be tested, as may be determined based on one or more inputs within user interface 115 (e.g., to initiate execution of an instance of testing engine 116), as part of a continuous integration and continuous deployment (CI/CD) pipeline, or in response to some other trigger or event. For example, process 300 may be executed whenever a new tool 164 is registered or instantiated with platform 110, an existing tool 164 is modified, and/or the like.

While process 300 is illustrated with a certain arrangement and ordering of subprocesses, process 300 may be implemented with fewer, more, or different subprocesses and a different arrangement and/or ordering of subprocesses. Furthermore, any subprocess, which does not depend on the completion of another subprocess, may be executed before, after, or in parallel with that other independent subprocess, even if the subprocesses are described or illustrated in a particular order.

In a contemplated embodiment, a user initiates a session with testing engine 116. The initiation of a new session may be triggered by a user operation, such as the selection of an input by the user within the graphical user interface of user interface 115, the navigation of the user to a particular screen of the graphical user interface, the registration or modification of a tool 164, and/or the like.

In an embodiment, each session could be a real-time chat session, in which a user interacts (e.g., via user system 130) with testing engine 116 using natural-language inputs, and testing engine 116 responds to the user using natural-language responses. In other words, each of the inputs and the responses may comprise a natural-language expression. The natural-language inputs and/or responses may be provided in a textual format and/or audio format (e.g., using a speech-to-text engine to convert the user's speech to text to be processed by testing engine 116, and/or a text-to-speech engine to convert the textual response of testing engine 116 into speech to be output to the user). In some cases, the responses from testing engine 116 may comprise non-textual visual elements, such as images, videos, animations, slides, diagrams, storyboards, charts, graphical user interfaces, and/or other graphical content, potentially in combination with textual visual elements and/or audio elements.

In an alternative embodiment, each session utilizes a standard dialog, instead of a real-time chat session. In this case, information may be collected by testing engine 116, from a user, via a dialog box that prompts the user to input data (e.g., file(s), textual field values, etc.) via one or more inputs. The dialog box could implement a wizard, comprising a plurality of screens served in a sequential manner, in which one or more of the sequential screens may depend on an interaction of the user (e.g., via user system 130) with one or more preceding screens.

In an embodiment, testing engine 116 is itself an AI agent 160. In this case, testing engine 116 may utilize one or more AI models 162 (e.g., large language model) and/or zero, one, or more tools 164 to process inputs from the user, during the real-time chat session, and produce responses to those inputs during the real-time chat session, within chat interface 165. In other words, testing engine 116 may operate just as any other AI agent 160. Therefore, any description herein of AI agents 160 may equally apply to testing engine 116.

Initially, subprocess 310 may receive a tool specification that defines a tool 164 for an AI agent 160. The tool specification for a given tool 164 may comprise an identifier of the tool 164, a configuration of the tool 164 (e.g., comprising one or more parameter values for the tool 164), an API specification for application programming interface 163 of the tool 164, an objective of the tool 164, a description (e.g., purpose, capabilities, etc.) of the tool 164, a network address (e.g., URL, Internet Protocol (IP) address, etc.) of the tool 164, metadata about the tool 164, and/or the like. The API specification may comprise one or more operations (i.e., endpoints) implemented by the tool 164, input and/or output schemas of each operation, an authentication or security protocol for the tool 164, and/or the like. The tool specification may be input by a user, for example, by uploading a data file representing the tool specification, manually inputting the tool specification, providing a reference (e.g., hyperlink) to a resource representing the tool specification, and/or the like, via a real-time chat session (e.g., within chat interface 165) or other dialog (e.g., via user interface 115). For instance, the user may manually test a tool 164 and/or a CI/CD pipeline may automatically test a tool 164 for an AI agent 160, prior to deploying the tool 164 and/or AI agent 160. In this case, the user or CI/CD pipeline may submit the tool specification to testing engine 116.

Subprocess 320 may classify the tool 164 into one of a plurality of classifications based on the tool specification. Classification enables testing engine 116 to determine the most appropriate testing strategy. The plurality of classifications may represent all of the possible types of tools 164 available to AI agents 160 within computing environment 150. In particular, each of the plurality of classifications may represent a different type of tool 164. As an example, the plurality of classifications may comprise an application programming interface (e.g., a Representational State Transfer (REST) application programming interface), an integration process, a data hub (e.g., also known as a “knowledge base”), and/or the like.

Subprocess 320 may comprise a classifier, such as a machine-learning classifier, a rule-based classifier, or the like. Subprocess 320 may extract one or more features from the tool specification, and apply the classifier to the feature(s), to output the classification, from among the plurality of classifications. The feature(s) may comprise any relevant information from the tool specification, such as the objective or description of tool 164, the API specification or components of the API specification of the tool's application programming interface 163, including operations implemented by tool 164, metadata, and/or the like.

Subprocess 330 may generate a test suite based on the classification that was output by subprocess 320 and/or other relevant data derived from the tool specification that was received in subprocess 310. In particular, a generative model may be executed to generate a test suite, comprising or consisting of a plurality of test cases, based on the classification and/or other relevant data. The other relevant data may comprise data, extracted from the tool specification, as well as metadata about the tool, computing environment 150, and/or the like. For instance, the relevant data may comprise the objective or description of tool 164, the API specification of the application programming interface 163 of tool 164, including operations implemented by tool 164, input and/or output schemas for the operations, and/or the like, metadata, and/or the like. In an embodiment in which testing engine 116 is an AI agent 160, the generative model may be an AI model 162. The test suite, generated by subprocess 330, may comprise or consist of a plurality of base test cases. Each test case in the test suite may be defined by a configuration of the test case (e.g., an operation of tool 164 to be called, values of input parameters to the operation, etc.), an expected response or behavior of the test case, expected or historical metrics of the test case (e.g., expected execution time, historical success rate, etc.), a priority of the test case, a contribution of the test case to coverage (e.g., whether or not the test case tests authentication, the validity of a path, etc.), and/or the like.

Subprocess 340 may apply an optimization model to the test suite, which was generated and output by subprocess 330, to optimize the test suite. In particular, subprocess 340 may apply an optimization model to select and/or refine test cases, representing scenarios that maximize coverage, while minimizing execution time and resource utilization. In other words, subprocess 340 may optimally balance the coverage of the testing with the computational cost incurred by testing. It should be understood that, in this context, “coverage” refers to the extent to which the test suite tests every possible interaction with and utilization of tool 164. The output of subprocess 340 may be an optimized test suite that is significantly smaller in size than the original test suite that was output by subprocess 330, but which possesses identical or similar (e.g., within 10%, and preferably within 5%) coverage as the original test suite, at lower computational cost (e.g., lower execution time, fewer computational resources, etc.).

Subprocess 350 may detect one or more edge test cases based on the tool specification that was received in subprocess 310, the classification that was output by subprocess 320, and/or the test suite, and add the detected edge test case(s), as test cases, to the test suite (e.g., as optimized by subprocess 340). In particular, subprocess 350 may identify boundaries that are likely to cause exceptions and/or rare scenarios that may produce unusual responses. These are scenarios that the generation of base test cases by subprocess 330 will typically overlook. Each edge test case that is detected and added to the test suite may be defined in the same manner or a different manner as the base test cases. In an embodiment, each edge test case may be defined by a unique identifier, a name, a set of parameters, a set of steps, an expected behavior, an anomaly score, a rationale for including the edge test case, and/or the like.

Subprocess 360 may execute the test suite, including the base test cases, generated by subprocess 330 and optimized by subprocess 340, and the edge test case(s), detected and added by subprocess 350, to produce a test result. Subprocess 360 may execute the test suite, manage the execution of the test suite, analyze the results of the execution of the test suite, and output the results of the analysis.

Subprocess 370 may output the test result from the execution of the test suite in subprocess 360. The test result may comprise an analytic result of an analysis performed on result data collected during and/or at the end of testing. The analytic result may comprise results of the test cases that were run, as well as performance metrics about the execution of the test suite. The results of the test cases may indicate which test cases failed, which test cases were successful, failure metrics, success metrics, coverage metrics, and/or the like, information about why test cases failed, suggestions for improving the test suite, and/or the like. The performance metrics may comprise computational time, a measure of computational resources that were required, and/or the like. Outputting the test result may comprise displaying a representation of the test result within the user interface of testing engine 116. In an embodiment in which testing engine 116 is itself an AI agent 160, the representation of the test result may be displayed in chat interface 165, during a real-time chat session with generation engine 116. Alternatively, the representation of the test result may be displayed within user interface 115.

Subprocess 380 may receive feedback on the test result, output by subprocess 370. This feedback may comprise modifications to the test suite (e.g., prior to re-execution of the test suite), such as the addition of test cases, the removal of test cases, a change in coverage targets and/or constraints, a change in ratio of certain test cases (e.g., edge cases to base cases, test cases that test one component to test cases that test another component, etc.), and/or the like. In particular, the user may interact with the representation of the test result in an intuitive manner, to review any component of the test result, modify the test suite, approve the tested tool 164 and/or AI agent 160, deploy the tested tool 164 and/or an AI agent 160 that utilizes the tested tool 164, and/or the like. For example, the user interface of testing engine 116 may be a graphical user interface that comprises one or more inputs for such review, modification, approval, and/or deployment. Any modifications and/or approvals may be recorded as feedback. Alternatively or additionally, the user interface of testing engine 116 may comprise one or more explicit feedback inputs, such as an input for indicating approval of the test result and/or an input for indicating disapproval of the test result.

Subprocess 390 may refine one or more of the models utilized by testing engine 116, based on the feedback. In an embodiment in which testing engine 116 is an AI agent 160, these model(s) may comprise AI model(s) 162. Any of the models described herein, including the classifier in subprocess 320, the generative model in subprocess 330, the optimization model in subprocess 340, an edge-detection model in subprocess 350, a test prioritization model and/or analysis model in subprocess 360, and the like, may be refined (e.g., retrained, fine-tuned, etc.) based on the feedback. In the case of supervised learning, this refinement may comprise generating a training dataset, comprising feature vectors labeled with targets, from the feedback, and fine-tuning a model to minimize a loss between the outputs, inferred by the model for the feature vectors, and the respective targets with which those feature vectors are labeled. Subprocesses 380 and 390 enable continuous learning and improvement of testing engine 116.

In cases in which the test result, output by subprocess 370, was not acceptable to a user, the tested tool 164 and/or the test suite may be modified, and tool 164 may be retested, for example, via another iteration of subprocess 300. It should be understood that this may continue, over each of a plurality of iterations, until the test result is acceptable to the user.

Once a user is satisfied with the test result for tool 164, the user may deploy tool 164 and/or an AI agent 160 that utilizes tool 164, for example, to a registry of platform 110, so that it can be utilized or otherwise accessed within computing environment 150. Alternatively or additionally, the tool 154 and/or AI agent 160 may be deployed to computing environment 150. As mentioned elsewhere herein, in an embodiment, computing environment 150 is an iPaaS platform.

In an embodiment, process 300 could be integrated into a continuous integration and continuous deployment (CI/CD) pipeline for automated testing and validation. A CI/CD pipeline is an automated workflow that enables development teams to build, test, and deploy software entities—in this case, AI agents 160 and/or tools 164—continuously. In continuous integration, developers frequently integrate code into a shared repository, with each integration triggering automated builds and testing. Process 300 may be integrated into this continuous integration to perform the automated testing of AI agents 160 and/or tools 164 being developed. In particular, process 300 may be triggered each time a tool 164 is updated (e.g., when the respective application programming interface 163 is modified) and/or an AI agent 160 is updated. In continuous deployment, the modified software entity is automatically deployed to production (i.e., without manual intervention).

In an embodiment, a performance monitoring and analysis module may be provided. The performance monitoring and analysis module may continuously monitor performance metrics of each tool 164, including its respective application programming interface 163, periodically or in real time. The performance monitoring and analysis module may apply machine-learning-based anomaly detection and/or trend analysis to the performance metrics. The results of such analysis may be presented within a dashboard (e.g., of user interface 115) that provides real-time visibility into the health of each tool 164, including any potential issues that may impact the operation of each tool 164.

### 4. Classification

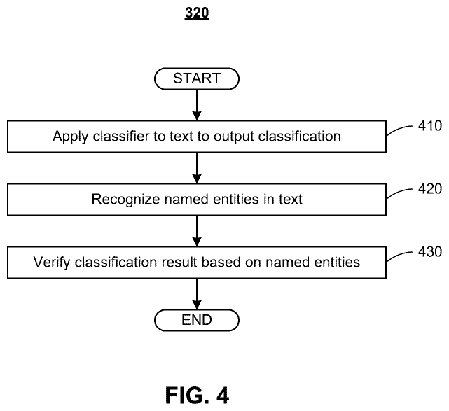

FIG. 4 illustrates an example of subprocess 320 for classifying tool 164, according to an embodiment. While subprocess 320 is illustrated with a certain arrangement and ordering of subprocesses, subprocess 320 may be implemented with fewer, more, or different subprocesses and a different arrangement and/or ordering of subprocesses. Furthermore, any subprocess, which does not depend on the completion of another subprocess, may be executed before, after, or in parallel with that other independent subprocess, even if the subprocesses are described or illustrated in a particular order.

Subprocess 410 may apply a classifier to one or more elements that comprise text fields that have been extracted or otherwise derived from the tool specification (e.g., received in subprocess 310), such as the name or other identifier of tool 164, the objective or description of tool 164, and/or the like. Alternatively or additionally, the element(s) may comprise or consist of the entire tool specification itself, which may be provided in JavaScript Object Notation (JSON) or any other suitable format. Alternatively or additionally, the element(s) may comprise metadata about tool 164, such as interaction patterns between AI agents 160 and tool 164. The output of the classifier may comprise or consist of an output vector comprising, for each of the plurality of classifications, a probability (e.g., confidence score) that, that classification is the true classification (e.g., with the all of the confidence scores summing to one). Alternatively, the output of the classifier could be a single classification with the highest probability (e.g., highest confidence score).

In an embodiment, the classifier comprises or consists of a language model that is based on the transformer architecture, such as Bidirectional Encoder Representations from Transformers (BERT), as disclosed in J. Devlin et al., “BERT: Pre-training of Deep Bidirectional Transformers for Language Understanding,” arXiv: 1810.04805, which is hereby incorporated herein by reference as if set forth in full, or any of its extensions, such as Robustly Optimised BERT pretraining Approach (ROBERTa), ROBERTa-Large, A Lite BERT (ALBERT), Distilled BERT (DistilBERT), StructBERT, or Decoding-enhanced BERT with disentangled Attention (DeBERTa). A preferred embodiment utilizes DistilBERT as the classifier, for its relative efficiency. Alternatively, another language model may be used, such as any small or large language model, including any of the language models mentioned herein.

The classifier may be trained, using supervised learning, on a training dataset that comprises a plurality of labeled feature sets (e.g., feature vectors). Each of the plurality of labeled feature sets may represent a respective tool 164 and comprise the element(s) to be used for classification, labeled with a ground-truth classification for the respective tool 164. Again, the feature set may comprise or consist of text fields, extracted or other derived from the tool specification for the respective tool 164, the entire tool specification, and/or metadata about the respective tool 164 (e.g., interaction patterns between the respective tool 164 and AI agents 160).

Subprocess 420 may recognized named entities in text that has been derived from the tool specification. This named entity recognition (NER) may be performed by an NER model on the same text fields, tool specification, and/or metadata representing the element(s) used for classification in subprocess 410, and/or different text than the element(s) used for classification in subprocess 410. In an embodiment, the NER model is applied to the description of tool 164, within the tool specification, and/or the description of each available operation of tool 164, within the API specification.

NER models encompass dictionary-based, rules-based, and machine-learning models, including deep-learning models. Essentially, an NER model recognizes and classifies named entities in the input into predefined categories. The output of the NER model may comprise, for each recognized named entity, the classification of the named entity (e.g., into one of the same plurality of classifications as used to classify tool 164 as a whole, or into one of a different plurality of classifications), a position of the named entity within the input, a confidence score that the named entity has been properly classified, and/or the like.

In an embodiment, the NER model comprises or consists of a spaCy-based model. SpaCy is an open-source natural language processing (NLP) library in Python, which includes pre-trained models (e.g., transformers, convolutional neural networks, etc.) for tokenization, part-of-speech tagging, dependency parsing, named entity recognition, lemmatization, and the like. The spaCy NER model can be fine-tuned or customized for domain-specific tasks using a labeled training dataset. Accordingly, the spaCy NER model may be customized for identifying domain-specific entities. For example, for a REST application programming interface, the domain-specific entities may include “HTTP endpoint,” “API key,” “token,” and the like. It should be understood that other domain-specific entities would be used for the other possible classifications of tool 164. In an alternative embodiment, a different NER model may be used in subprocess 420.

Subprocesses 410 and 420 may be performed by different models or the same model. In either case, the input may first be tokenized. During tokenization, the input, which may comprise a string of text, is broken down into units, called “tokens,” that serve as the basic building blocks for further linguistic analysis, for example, by the disclosed models. A single token may represent a plurality of words, a single word, or a sub-word (e.g., one or more characters that themselves do not form a complete word, but may form a prefix, suffix, or the like).

In an embodiment in which subprocesses 410 and 420 are performed by the same model, the model can be applied to the set of tokens, in a first pass, to classify tool 164 into one of the plurality of classifications, and then again, in a second pass, to recognize any named entities. In an alternative embodiment, the architecture of the model may be modified to create a multi-task model that simultaneously performs both tool classification and named entity recognition. For example, the ROBERTa-Large model may be used. In this case, the ROBERTa-Large encoder may convert the tokens into token embeddings, and then a first head may process the token embeddings for tool classification, while a second head simultaneously processes the token embeddings for named entity recognition. It should be understood that the ROBERTa-Large model is simply one example, and that, in alternative embodiments, a different model may be used, including the BERT model or another model derived from or based on the BERT model.

Subprocess 430 may verify the classification, output by subprocess 410, based on the named entities, recognized in subprocess 420. In an embodiment, the named entities, recognized by subprocess 420, may contribute to the confidence scores of the classifications, output by subprocess 410. For example, as mentioned above, the output of subprocess 410 may be an output vector comprising the confidence score for each of the plurality of classifications. The presence of a particular named entity, within the input, that is particularly relevant to one of the plurality of classifications may increase the confidence score of that classification, relative to the other classifications. Conversely, the presence of a conflicting indicator may decrease the confidence score of the classification. Subprocess 430 may adjust the confidence scores, based on the recognized named entities, according to one or more rules. Alternatively or additionally, subprocess 430 may cross-check the recognized named entities with the tool specification or other reference, to confirm the classification that was output by subprocess 410, and/or determine whether or not there are any conflicting indicators that would suggest that the classification that was output by subprocess 410 is incorrect. For instance, the classifications of the recognized named entities, from subprocess 420, may be compared to the classification of tool 164, output by subprocess 410. In this case, the classification of tool 164 may be verified if the classifications match, or unverified if the classifications do not match.

In some cases, subprocess 430 may be unable to verify a classification. For example, no classification may have a confidence score that satisfies (e.g., is greater than or equal to) a predefined threshold, or the recognized named entities may conflict with the classification of tool 164. In these cases, subprocess 430 may trigger a further analysis of the tool specification and/or other data to produce a final classification for tool 164.

As a concrete, non-limiting example, for the purposes of illustration, the following description from a tool specification is utilized:

This tool calls Salesforce with an HTTP GET request to retrieve
all open cases in ascending creation order. It uses a Bearer token
in the header for authentication.

The tool specification may also include the following API specification:

```
{
  “id”: “a6c7d8e5-7bea-4304-aaf0-d339224775bf”,
  “created_on”: “2025-03-08T15:58:19.607684Z”,
  “last_updated_on”: “2025-03-09T16:44:04.195614Z”,
  “created_by”: “john.doe@test.com”,
  “last_updated_by”: “john.doe@test.com”,
  “last_used_on”: null,
  “installed_on”: “2025-03-08T15:59:16.340085Z”,
  “name”: “Salesforce - Get Cases”,
  “description”: “Get all open cases from Salesforce in FIFO
order”,
  “input_parameters”: [ ],
  “base_url”: “https://test-1d-dev-
ed.develop.my.salesforce.com”,
  “path”: “/services/data/v59.0/query”,
  “method”: “GET”,
  “query_parameters”: [
    {
      “name”: “q”,
      “value”: “SELECT Id, CaseNumber, Subject, Status
FROM Case WHERE IsClosed = false ORDER BY CreatedDate ASC”
    }
  ],
  “path_parameters”: [ ],
  “headers”: [
    {
      “name”: “Authorization”,
      “input_parameter_name”: null,
      “static_value”: “Bearer <token>”
    }
  ],
  “authentication”: null,
  “request_body”: null
}
```

In this case, the output of the classifier in subprocess 410 may be:
[REST API: 0.90, Integration: 0.05, Datahub: 0.05]
   This represents that there is a 90% probability that tool 164 is a REST application programming interface, a 5% chance that tool 164 is an integration process, and a 5% chance that tool 164 is a data hub.

Subprocess 420 may recognize the following named entities in the description:
[“HTTP GET request”, REST indicator, “Bearer token”]

Subprocess 430 may confirm the presence of “base_url” and REST-style headers in the tool specification, which supports the classification as a REST application programming interface. In addition, subprocess 430 may determine that no conflicting indicators exist, which also supports the classification as a REST application programming interface. Consequently, subprocess 430 may output the final classification of tool 164 as a REST application programming interface.

### 5. Test Suite Generation

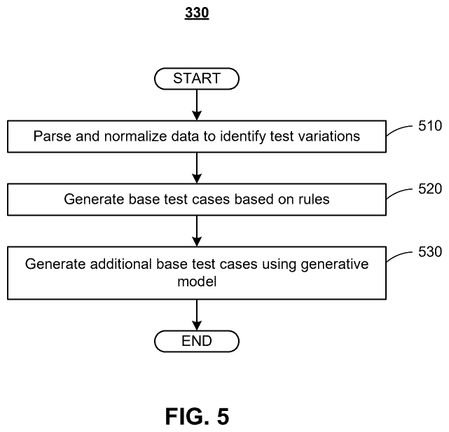

FIG. 5 illustrates an example of subprocess 330 for generating a test suite, according to an embodiment. While subprocess 330 is illustrated with a certain arrangement and ordering of subprocesses, subprocess 330 may be implemented with fewer, more, or different subprocesses and a different arrangement and/or ordering of subprocesses. Furthermore, any subprocess, which does not depend on the completion of another subprocess, may be executed before, after, or in parallel with that other independent subprocess, even if the subprocesses are described or illustrated in a particular order.

Subprocess 510 may parse or otherwise derive one or more elements from the tool specification, including the API specification, and/or metadata. These elements may comprise an objective or description of tool 164, elements from the API specification of tool 164, such as operations (e.g., endpoints) implemented by tool 164, an authentication or security protocol, and/or other parameters of the API specification, and/or the like. Additionally or alternatively, these elements may comprise domain constraints (e.g., rate limits) from the metadata. Subprocess 510 may normalize the parsed elements, and identify the value of each of one or more variables representing test variations.

Subprocess 520 may generate a first set of test cases based on one or more rules, applied to the classification of tool 164 and/or the tool specification (e.g., the element(s) output by subprocess 510). For example, test cases may be generated using standard test patterns. These standard test patterns may include, without limitation, valid and invalid credentials for authentication, parameter validation tests for missing, malformed, and/or boundary values, verification tests for HTTP status codes, and/or the like.

Subprocess 530 may generate a second set of test cases by applying a generative model to the classification of tool 164 and/or the tool specification (e.g., the element(s) output by subprocess 510). The element(s) used in subprocess 530 may be the same as or different from the element(s) used in subprocess 520. In an embodiment in which testing engine 116 is an AI agent 160, the generative model may be an AI model 162. The generative model may be applied to the elements, output by subprocess 510, the classification determined by subprocess 320, domain-specific testing heuristics, and/or the like, as input. The generative model may output a plurality of test cases, for example, in an array in JSON format. The output may comprise, for each of the plurality of test cases, one or more test parameters, an expected result of the test, validation criteria for the test, a priority level of the test, and/or the like.

In an embodiment, the generative model used by subprocess 530 is a generative language model, such as a large language model that has been trained on domain-specific knowledge about testing. In this case, subprocess 530 may generate a prompt using the elements, output by subprocess 510, the classification determined by subprocess 320, domain-specific testing heuristics, and/or the like, for example, by inserting these data into a predefined template. In other words, the prompt may incorporate the classification and one or more elements, derived from the tool specification, and instruct the large language model to generate the test suite. The predefined template may comprise a pre-conversation and/or post-conversation, which provide context and/or instructions for the generative language model, and a placeholder into which the data are inserted. The pre-conversation and/or post-conversation may define the role of the generative language model (e.g., to generate the test suite), define an output format for the generative language model (e.g., a list structure, a hierarchical structure, a markup-language structure, such as JSON, etc.), and/or the like. Subprocess 530 may input the prompt, once generated, to the large language model to generate the test suite as output.

Notably, the combination of subprocesses 520 and 530 represents a hybrid approach that utilizes both rule-based and machine-learning approaches to generate test cases that capture functional scenarios, edge conditions, and negative paths, based on the tool specification, tool classification, and domain knowledge. The output of subprocess 330 will be a test suite comprising or consisting of the first set of test cases generated by rules in subprocess 520 and the second set of test cases generated by the generative model in subprocess 530.

Continuing the concrete example from above, the output of subprocess 330 may be:

```
[
  {
    “test_id”: “SF-TC-001”,
    “name”: “Valid Authorization - Standard Query”,
    “url”: “https://test-1d-dev-
ed.develop.my.salesforce.com/services/data/v59.0/query”,
    “method”: “GET”,
    “headers”: {“Authorization”: “Bearer valid_token”},
    “query_parameters”: {“q”: “SELECT Id, CaseNumber, Subject,
Status FROM Case WHERE IsClosed = false ORDER BY CreatedDate
ASC”},
    “expected_status”: 200,
    “validation_criteria”: [
      {“type”: “json_schema”, “schema_ref”:
“salesforce_cases_schema.json”},
      {“type”: “data_check”, “condition”: “Array length > 0 if
any open cases exist”}
    ],
    “priority”: “high”
  },
  {
    “test_id”: “SF-TC-002”,
    “name”: “Invalid Authorization Token”,
    “url”: “https://test-1d-dev-
ed.develop.my.salesforce.com/services/data/v59.0/query”,
    “method”: “GET”,
    “headers”: {“Authorization”: “Bearer invalid_token”},
    “query_parameters”: {“q”: “SELECT Id, CaseNumber, Subject,
Status FROM Case WHERE IsClosed = false ORDER BY CreatedDate
ASC”},
    “expected_status”: 401,
    “validation_criteria”: [
      {“type”: “error_code”, “expected_code”:
“INVALID_SESSION_ID”}
    ],
    “priority”: “high”
  }
]
```

It should be understood that the test suite, output by subprocess 330, would be different if tool 164 had been classified into a different one of the plurality of classifications than a REST application programming interface. For example, if tool 164 had instead been classified as an integration process, the test suite would comprise test cases that are specific to integration processes. Similarly, if tool 164 had instead been classified as a data hub, the test suite would comprise test cases that focus on field validations and data-hub model specifications. In other words, the test cases that are generated for the test suite are focused on the classification-specific operational characteristics of tool 164.

### 6. Test Suite Optimization

As introduced elsewhere herein, subprocess 340 optimizes the test suite of base test cases, output by subprocess 330. In an embodiment, subprocess 340 applies an optimization model to the test suite. In particular, the optimization model may be applied to the full test suite, feature vectors for each test case in the test suite, coverage target(s), coverage constraint(s), and/or the like. The feature vector for each test case may comprise the value of one or more parameters for the test case, such as the contribution of the test case to total coverage of all scenarios, the expected execution time of the test case, the expected effectiveness of the test case, and/or the like. Parameters, such as expected execution time and expected effectiveness, may be based on historical data for identical or similar test cases. The output of the optimization model may comprise an optimized subset of the plurality of test cases from the test suite, a value score for each test case in the optimized subset, coverage metrics for the optimized subset, and/or the like. It should be understood that the optimized subset of test cases may consist of a significantly smaller number of test cases than the original test suite. This optimized subset of test cases becomes the optimized test suite, output by subprocess 340.

In an embodiment, the optimization model comprises an extreme Gradient Boosting (XGBoost) ranking model. XGBoost supports ranking using pairwise or listwise objectives, and is described in detail in “XGBoost: A Scalable Tree Boosting System,” by Chen et al., arXiv: 1603.02754 [cs.LG], which is hereby incorporated herein by reference as if set forth in full. The XGBoost ranking model may be trained to rank the plurality of tests cases in the test suite according to their feature vectors, in order to optimally fit the coverage target(s), subject to any coverage constraints. Thus, for example, test cases with higher contributions to coverage, lower expected execution times, higher expected effectiveness, and/or the like, may be ranked higher than test cases with lower contributions to coverage, higher expected execution times, lower expected effectiveness, and/or the like. The optimized subset of test cases may be extracted from the ranked list of test cases, output by the XGBoost ranking model. It should be understood that XGBoost is just one example, and that, in alternative embodiments, a different ranking model, including a different gradient-boosting model, or other type of model may be used instead of XGBoost.

Continuing the concrete example from above, assume that the input to subprocess 340, representing the unoptimized test suite, is:

```
[
  {
    “test_id”: “SF-TC-001”,
    “execution_time”: 0.5,
    “covers_authentication”: true,
    “covers_happy_path”: true,
    “historical_success_rate”: 0.99,
    “priority”: 1
  },
  {
    “test_id”: “SF-TC-002”,
    “execution_time”: 0.3,
    “covers_authentication”: true,
    “covers_happy_path”: false,
    “historical_success_rate”: 0.98,
    “priority”: 2
  },
  {
    “test_id”: “SF-TC-003”,
    “execution_time”: 0.3,
    “covers_authentication”: true,
    “covers_happy_path”: false,
    “historical_success_rate”: 0.99,
    “priority”: 3
  }
]
```

In this case, the optimized test suite that is output by subprocess 340 may be:

```
{
  “selected_tests”: [“SF-TC-001”, “SF-TC-002”],
  “coverage_metrics”: {
    “authentication”: 1.0,
    “happy_path”: 1.0,
    “error_cases”: 0.7
  },
  “total_execution_time”: 0.8,
  “justification”: “Test SF-TC-003 was excluded as it provides
redundant authentication coverage already provided by SF-TC-002”
}
```

### 7. Edge Detection

As introduced elsewhere herein, subprocess 350 detects and adds one or more, and generally a plurality of, edge test cases to the test suite. In an embodiment, subprocess 350 utilizes one or more, and preferably a plurality of, edge-detection models to identify edge test cases.

The edge-detection model(s) may comprise a transformer-based fuzzy model. The transformer-based fuzzy model may accept, as input, the tool specification, including the API specification, one or more domain-specific constraints, one or more historical failure patterns, and/or the like. The transformer-based fuzzy model may output the parameters of semantically meaningful edge test case(s), an expected behavior of each of the generated edge test cases, a risk score of each of the generated edge test cases, and/or the like.

Additionally or alternatively, the edge-detection model(s) may comprise an anomaly detection ensemble. The anomaly detection ensemble may comprise a combination of an isolation forest, autoencoder, one-class Support Vector Machine (SVM), and/or the like. The anomaly detection ensemble may accept, as input, historical API usage patterns, parameter distributions from historical usage logs comprising past API calls, feature vectors representing past successful and/or failed API calls, and/or the like. The anomaly detection ensemble may output combinations of parameters that produce anomalies, anomaly scores, suggestions for test cases representing uncovered anomalies, and/or the like.

Continuing the concrete example from above, the output of subprocess 350 may be:

```
[
  {
    “edge_case_id”: “EC-001”,
    “name”: “Zero Results Query”,
    “modification”: {
      “query_parameters”: {
        “q”: “SELECT Id, CaseNumber, Subject, Status FROM Case
WHERE IsClosed = false AND Status = ‘Non_Existent_Status’ ORDER
BY CreatedDate ASC”
      }
    },
    “expected_behavior”: “Empty array response with 200 status”,
    “anomaly_score”: 0.82,
    “rationale”: “Tests handling of valid query with no matching
results”
  },
  {
    “edge_case_id”: “EC-002”,
    “name”: “Rate Limit Approach Test”,
    “test_type”: “sequence”,
    “steps”: [
      {“repeat”: “basic_query”, “times”: 95, “interval”: 0.2},
      {“verify”: “response_degradation”, “metric”: “latency”}
    ],
    “anomaly_score”: 0.91,
    “rationale”: “Tests API behavior as it approaches Salesforce
rate limits”
  }
]
```

### 8. Test Suite Execution

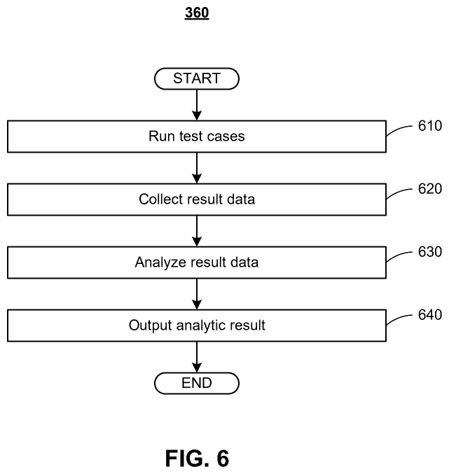

FIG. 6 illustrates an example of subprocess 360 for executing a test suite, according to an embodiment. The input to subprocess 360 may comprise or consist of the optimized test suite, with the added edge test case(s), output by subprocess 350. While subprocess 360 is illustrated with a certain arrangement and ordering of subprocesses, subprocess 360 may be implemented with fewer, more, or different subprocesses and a different arrangement and/or ordering of subprocesses. Furthermore, any subprocess, which does not depend on the completion of another subprocess, may be executed before, after, or in parallel with that other independent subprocess, even if the subprocesses are described or illustrated in a particular order.

Subprocess 610 may run the plurality of test cases in this test suite. In particular, the plurality of test cases may be run by an execution engine. The execution engine may run two or more of the plurality of test cases in parallel, to reduce the overall computational time of running the test cases. Additionally or alternatively, the execution engine may run subsets of the test cases in batches, in serial and/or in parallel. The execution engine may also provide management of the testing environment, resolution of dependencies between test cases, and logic for retrying a test case that fails with one or more back-off strategies.

The execution engine may comprise an API response validation module, which validates responses from application programming interface 163 of tool 164. This validation may comprise advanced data comparison techniques to compare expected responses to actual responses from application programming interface 163. Additionally or alternatively, the validation may comprise the application of a machine-learning model to the responses from application programming interface 163, to detect one or more anomalies in the responses. Additionally or alternatively, the validation may compare benchmark performance metrics against actual performance metrics collected for test-case calls to application programming interface 163. More generally, the API response validation module may compare the expected operation of application programming interface 163 to the actual operation of application programming interface 163, during execution of the test suite.

Additionally or alternatively, the execution engine may comprise a compatibility verification module, which checks that tool 164 (e.g., application programming interface 163) is compatible with the objectives of the AI agent 160 that is to utilize tool 164. For example, the compatibility verification module may check data consistency, error handling, adherence to expected behavior, and/or the like. The compatibility verification module may output a compatibility score for tool 164, representing the compatibility of tool 164 with AI agent 160. In the event of a low compatibility score, the tool 164 may be removed from AI agent 160 and/or replaced with a more compatible tool 164. Thus, the compatibility verification module may be used to identify and fill gaps in the tools 164, available to an AI agent 160, with respect to the objectives of that AI agent 160.

Additionally or alternatively, the execution engine may comprise a test prioritization reinforcement learning (RL) model that prioritizes the plurality of test cases in the test suite. The test prioritization RL model may accept, as input, metadata for the tests that were run, historical performance data for the tests that were run, the current system state, a development context (e.g., including any recent changes), and/or the like. The test prioritization RL model may output an optimized test execution order, expected fault detection metrics, time-to-detection estimates, and/or the like. The test cases may be run, in subprocess 610, in the order specified by the optimized test execution order.

Subprocess 620 may collect result data. The result data may comprise or consist of the results of each of the plurality of test cases that have been run in subprocess 610. It should be understood that subprocess 620 may occur in parallel with subprocess 610, to collect the result data in real time as the test cases are run. As used herein, the term “real time” or “real-time” contemplates events that occur simultaneously, as well as events that are temporally separated from each other by ordinary delays resulting from latencies in processing, communications, memory access, and/or the like. Alternatively or additionally, subprocess 620 may occur after completion of subprocess 610.

Subprocess 620 may comprise an error detection and handling mechanism. The error detection and handling mechanism may detect and capture tool-specific errors and API exceptions during execution of the test suite. The error detection and handling mechanism may also generate a detailed report of the captured errors and exceptions, potentially including suggestions for troubleshooting.

Subprocess 630 may analyze the result data, collected by subprocess 620. Subprocess 630 may occur in parallel with subprocess 620 and/or after all result data have been collected by subprocess 620. In particular, the result data may be analyzed by an analysis engine. The analysis engine may detect anomalies in the result data, identify performance trends in the result data, identify correlations between failures in the result data, identify the root causes of failures in the result data, and/or the like. The analysis engine may comprise one or more analysis models to evaluate the test cases that were run.

The analysis model(s) may comprise a test flakiness prediction model. The test flakiness prediction model may accept, as input, historical execution results for the test cases that were run, environmental factors during the run of each test case, code change metrics associated with failed test cases, and/or the like. The test flakiness prediction model may output, for each test case that has been run, a flakiness score for the test case (e.g., on an interval from zero to one), a confidence score for the result of the test case (e.g., on a confidence interval from zero to one), one or more key factors contributing to the flakiness score for the test case, and/or the like.

Subprocess 640 may output the analytic result of subprocess 630. The analytic result may comprise performance insights, actionable recommendations for optimization and improvement, and/or the like. Continuing the concrete example from above, the analytic result may comprise:

```
{
  “execution_order”: [
    {
      “test_id”: “SF-TC-002”,
      “priority_score”: 0.95,
      “rationale”: “Authentication tests detect blocking issues
early”
    },
    {
      “test_id”: “SF-TC-001”,
      “priority_score”: 0.88,
      “rationale”: “Critical happy path test”
    },
    {
      “test_id”: “EC-001”,
      “priority_score”: 0.67,
      “rationale”: “Important edge case with recent similar
failures”
    }
  ],
  “estimated_fault_detection_rate”: 0.92,
  “estimated_full_execution_time”: 1.2
}
```

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

As used herein, the terms “comprising,” “comprise,” and “comprises” are open-ended. For instance, “A comprises B” means that A may include either: (i) only B; or (ii) B in combination with one or a plurality, and potentially any number, of other components. In contrast, the terms “consisting of,” “consist of,” and “consists of” are closed-ended. For instance, “A consists of B” means that A only includes B with no other component in the same context.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to, by a testing engine:
receive a tool specification that defines a tool for an artificial intelligence (AI) agent;
classify the tool into one of a plurality of classifications based on the tool specification;
generate a test suite, comprising a plurality of test cases, based on the one classification, using a generative model;
apply an optimization model to the test suite to optimize the test suite;
detect one or more edge cases based on the tool specification;
add the detected one or more edge cases, as test cases, to the test suite;
execute the test suite on the tool to produce a test result; and
output the test result.

2. The method of claim 1, wherein the tool specification comprises an application programming interface (API) specification that defines an application programming interface of the tool.

3. The method of claim 1, wherein classifying the tool comprises:
extracting one or more features from the tool specification; and
applying a machine-learning classifier to the one or more features to output the one classification.

4. The method of claim 3, wherein applying the machine-learning classifier comprises:
applying a language model to the one or more features to determine the one classification;
applying a named entity recognition (NER) model to the one or more features to recognize one or more named entities within the one or more features; and
verify the one classification based on the one or more named entities.

5. The method of claim 1, wherein each of the plurality of classifications represents a different one of a plurality of types of tool than any other of the plurality of classifications.

6. The method of claim 1, wherein the plurality of types of tool comprises a Representational State Transfer (REST) application programming interface, an integration process, and a data hub.

7. The method of claim 1, wherein the generative model comprises a large language model.

8. The method of claim 7, wherein executing the generative model to generate the test suite comprises:
generating a prompt that incorporates the one classification and one or more elements derived from the tool specification, and instructs the large language model to generate the test suite; and
inputting the prompt to the large language model to generate the test suite as output.

9. The method of claim 1, wherein generating the test suite comprises:
generating a first set of test cases based on one or more rules, applied to the one classification and one or more first elements derived from the tool specification; and
generating a second set of test cases by applying the generative model to the one classification and one or more second elements derived from the tool specification;
wherein the test suite comprises the first set of test cases and the second set of test cases.

10. The method of claim 1, wherein optimizing the test suite comprises reducing a number of the plurality of test cases within the test suite, while maintaining a similar coverage as the test suite prior to optimization.

11. The method of claim 1, wherein the optimization model comprises an extreme Gradient Boosting (XGBoost) ranking model.

12. The method of claim 1, wherein detecting the one or more edge cases comprises executing one or more edge-detection models.

13. The method of claim 12, wherein the one or more edge-detection models comprise a transformer-based fuzzy model.

14. The method of claim 12, wherein the one or more edge-detection models comprise an anomaly detection ensemble that includes two or more of an isolation forest, an autoencoder, or a support vector machine.

15. The method of claim 1, wherein the generation engine is an AI agent.

16. The method of claim 1, further comprising using the at least one hardware processor to:
receive feedback for the test suite; and
update one or more models of the testing engine based on the feedback.

17. The method of claim 1, further comprising using the at least one hardware processor to deploy the AI agent to a computing environment.

18. The method of claim 1, wherein the method is automatically executed within a continuous integration and continuous deployment (CI/CD) pipeline.

19. A system comprising:
at least one hardware processor; and
software that is configured to, when executed by the at least one hardware processor,
receive a tool specification that defines a tool for an artificial intelligence (AI) agent,
classify the tool into one of a plurality of classifications based on the tool specification,
generate a test suite, comprising a plurality of test cases, based on the one classification, using a generative model,
apply an optimization model to the test suite to optimize the test suite,
detect one or more edge cases based on the tool specification,
add the detected one or more edge cases, as test cases, to the test suite,
execute the test suite on the tool to produce a test result, and
output the test result.

20. A non-transitory computer-readable medium having instructions stored therein, wherein the instructions, when executed by a processor, cause the processor to:
receive a tool specification that defines a tool for an artificial intelligence (AI) agent;
classify the tool into one of a plurality of classifications based on the tool specification;
generate a test suite, comprising a plurality of test cases, based on the one classification, using a generative model;
apply an optimization model to the test suite to optimize the test suite;
detect one or more edge cases based on the tool specification;
add the detected one or more edge cases, as test cases, to the test suite;
execute the test suite on the tool to produce a test result; and
output the test result.
